(19) United States
(12) Patent Application Publication
(10) Pub. No.: US 2007/0074821 A1
(43) Pub. Date: Apr. 5, 2007

(54) Adhesive tape joining apparatus

(75) Inventors: Shinsuke Ikishima, Osaka (JP); Osamu Degawa, Osaka (JP)

Correspondence Address: RADER FISHMAN & GRAUER PLLC, LION BUILDING, 1233 20TH STREET N.W., SUITE 501, WASHINGTON, DC, 20036, US

(73) Assignee: NITTO DENKO CORPORATION

(21) Appl. No.: 11/541,731

(22) Filed: Oct. 3, 2006

(30) Foreign Application Priority Data
Oct. 4, 2005 (JP) JP2005-291157

(51) Int. Cl. B32B 37/00

(52) U.S. Cl. 156/543; 156/552

(57) ABSTRACT

To provide an adhesive tape joining apparatus, adhesive tape joining apparatus including: a pair of back and forth joining rollers which joins the adhesive tape to a main body that is moved and operated along the tape joining face of the workpiece by pressing the adhesive tape against the tape joining face and can be elastically transformed; a first guide roller which is engaged with the outer face of the workpiece being different from the tape joining face at a front position of the joining roller; and a pair of back and forth second guide rollers which is engaged with the workpiece at the portion of the opposite side of the tape joining face; wherein the first guide roller is mounted on the main body being fixed at a predetermined position thereof and the second guide roller is mounted on a movable bracket which is attached to the main body; and the movable bracket is biased to the side of the joining roller by an elastic body.

### BACKGROUND OF THE INVENTION

(1) Field of the Invention

The present invention relates to an adhesive tape joining apparatus used when an adhesive tape is joined to a curved workpiece such as a door sash of an automobile.

(2) Description of the Related Art

In recent years, in a manufacturing process of an automobile, in place of black coating processing on a door sash, a technology to join a black adhesive tape has been developed. For example, an adhesive tape joining apparatus (an adhesive tape joining jig) has been suggested. Herein, an adhesive tape from which a separator is separated is elastically pressed against a tape joining face with a joining roller to be joined thereto while guiding and moving this adhesive tape joining apparatus on hand along a workpiece (for example, refer to JP-A 2001-115117).

This adhesive tape joining apparatus is provided with four bottom guide rollers to be engaged on back and forth and right and left of a bottom face that is a tape joining face of the workpiece and four side guide rollers to be engaged on back and forth two places of the right and left side faces of the workpiece at its base. In addition, a single pressing roller to be elastically pressed against the upper face of the workpiece is mounted on a pressing lever that is pivotally connected to the base. Then, a bottom guide roller group and the pressing roller sandwich the workpiece vertically so as to keep the posture of the adhesive tape joining apparatus with respect to the workpiece. Further, by engaging the side guide rollers from right and left of the workpiece, positioning in a right and left direction of the adhesive tape joining apparatus with respect to the workpiece has been made.

Thus, the adhesive tape joining apparatus is moved along the workpiece with its position and its posture being determined due to the guidance of engagement by the roller group. The adhesive tape joining apparatus is configured in such a manner that, due to this movement, the adhesive tape is elastically pressed against the bottom of the workpiece by an elastic roller arranged at the rear end of the base to be joined thereto.

In other words, the suggested above-described adhesive tape joining apparatus is configured so as to, while keeping the position and the posture of the adhesive tape joining apparatus with respect to the workpiece by using the roller group such as the bottom guide roller, the side guide roller, and the pressing roller to be elastically pressed or the like, press the adhesive tape against the workpiece by the elastic roller located being separated rear position of these roller group. Accordingly, pressing up the adhesive tape joining apparatus upward and securely contacting the all bottom guide rollers against the bottom face of the workpiece, the elastic roller can be appropriately pressed against the bottom face of the workpiece.

However, upon depending on a level of applied force to operate the adhesive tape joining apparatus, the bottom guide roller at the rear position in the traveling direction floats from the bottom face and the entire adhesive tape joining apparatus slants backward and downward. In this state, it is feared that a joining malfunction is generated because the pressing force of the elastic roller against the bottom face of the workpiece runs short.

Accordingly, it is necessary for this adhesive tape joining apparatus to carry out the forward moving operation in a cautious manner while securely pressing the adhesive tape joining apparatus against the bottom face of the workpiece in parallel by an operator. As a result, the speed of the joining processing tends to decelerate.

### SUMMARY OF THE INVENTION

The present invention has been made taking the foregoing problems into consideration and an object of which is to provide an adhesive tape joining apparatus that can carry out adhesive tape joining operation lightly and promptly by stably pressing a joining roller against a joining face of a workpiece.

In order to attain the aforementioned object, the present invention may include the following structure as follows:

An adhesive tape joining apparatus which supplies an adhesive tape to a joining roller winding the adhesive tape around the joining roller while moving forward along a workpiece and joins this adhesive tape on a tape joining face of the workpiece by pressing the adhesive tape against the tape joining face, the apparatus including the follows:

A joining roller which joins the supplied adhesive tape to a main body that is moved and operated along the tape joining face of the workpiece by pressing the adhesive tape against the tape joining face of the workpiece and can be elastically transformed;

a first guide member which determines the position of the main body with respect to the workpiece being engaged with the outer face of the workpiece which is different from the tape joining face at a front position of the joining roller; and

a second guide member which is engaged with the workpiece at the portion of the opposite side of the tape joining face;

wherein

the first guide member is mounted being fixed at a predetermined position of the main body and the second guide member is mounted on a movable bracket which is attached to the main body; and

the movable bracket having the second guide member mounted thereto is biased to the side of the joining roller by an elastic body.

According to the adhesive tape joining apparatus, since the workpiece is elastically sandwiched by the joining roller and the second guide member, the posture of the adhesive tape joining apparatus toward the longitudinal direction of the workpiece is easily stabilized. In addition, even if the adhesive tape joining apparatus slants toward a forward moving direction slightly snaking against the workpiece, at least one of the back and force adhesive rollers is securely pressed on the joining face. In other words, this results in that the adhesive tape is stably pressed on the joining face.

Accordingly to this apparatus of the invention, even if the adhesive tape joining apparatus which is engaged and mounted on the workpiece is moved forward in a careless way, it is possible to carry out joining of the adhesive tape securely and smoothly in full pressing.

In this apparatus according to the present invention, it is preferable that the movable bracket is supported to the main body swinging around a support point which is directed backward and forward.

According to this structure, by swinging the movable bracket receding against a biasing force, it is possible to cover the workpiece with the joining roller and the second guide member being spaced each other. As a result, the adhesive tape joining apparatus can be easily mounted on the workpiece.

In addition, the first apparatus of the present invention is preferably configured as follows.

A movable bracket is supported so as to be capable of swinging by a third bracket which is fixed to the main body so as to be located at the opposite side of a bias direction of the movable bracket, and a support shaft which is inserted from back and forth of the main body inserting the movable bracket in an opening formed by the main body and the movable bracket when the movable bracket is fixed to a concave side formed on the main body; and providing the elastic body between the third bracket and the movable bracket, the movable bracket is biased to the side of the joining roller.

In addition, the adhesive tape joining apparatus is configured including the third bracket which is arranged at the opposite side of a bias direction of the movable bracket; and a rod which is mounted penetrating through the third bracket and the movable bracket so that its front end arrives at the main body; wherein the adhesive tape joining apparatus is configured so as to move the movable bracket slidably toward the side of the joining roller.

According to this structure, the apparatus of the present invention can be suitably realized.

In addition, it is preferable that the movable bracket is provided with a finger hanging part in order to move the movable bracket backward against the elastic body.

According to this structure, the operation for spacing the joining roller and the second guide member can be easily carried out in one hand.

In addition, it is preferable that the movable bracket is configured so that a movement limitation position at a bias direction can be varied and adjusted.

According to this structure, setting corresponding to a measurement and a specification of the workpiece is allowed, so that its general versatility is increased.

In addition, it is preferable that the movable bracket is configured so as to be able to vary and adjust a bias force by the elastic body.

According to this structure, in response to the measurement and the specification of the workpiece and a kind of the adhesive tape or the like, it is possible to preferably adjust a pressing force against the workpiece of the joining roller.

Further, it is preferable that the second guide member is configured by the second guide roller which is idled around a rotational axial core approximately in parallel with the rotational axial core of the joining roller.

According to this structure, it is possible to smoothly roll and move the second guide member with respect to the workpiece, so that the hand moving operation of the adhesive tape joining apparatus can be made lightly.

Further, it is preferable that the second guide roller is pressed and contacted to the outer convex curved face of a rib which is protruded along the longitudinal direction of the workpiece and a guide groove concave curved in the outer circumferential face of this second guide roller is formed circularly.

According to this structure, the position in the rotational axial core direction against the workpiece of the second guide roller (the second guide member) is stabilized, so that a degree of accuracy of positioning of the adhesive tape joining apparatus becomes higher.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a perspective view of an adhesive tape joining apparatus which is mounted on a workpiece;

FIG. 2 is a partially notched front view of the adhesive tape joining apparatus which is mounted on the workpiece;

FIG. 3 is a perspective view of the adhesive tape joining apparatus seen from other direction;

FIG. 4 is a cross sectional plan view of the adhesive tape joining apparatus;

FIG. 5 is a partially notched front view showing the adhesive tape joining apparatus according to other embodiment;

FIG. 6 is a partially notched front view showing the adhesive tape joining apparatus according to further other embodiment.

### DESCRIPTION OF THE PREFERRED EMBODIMENTS

An example of the present invention will be described below with reference to the drawings.

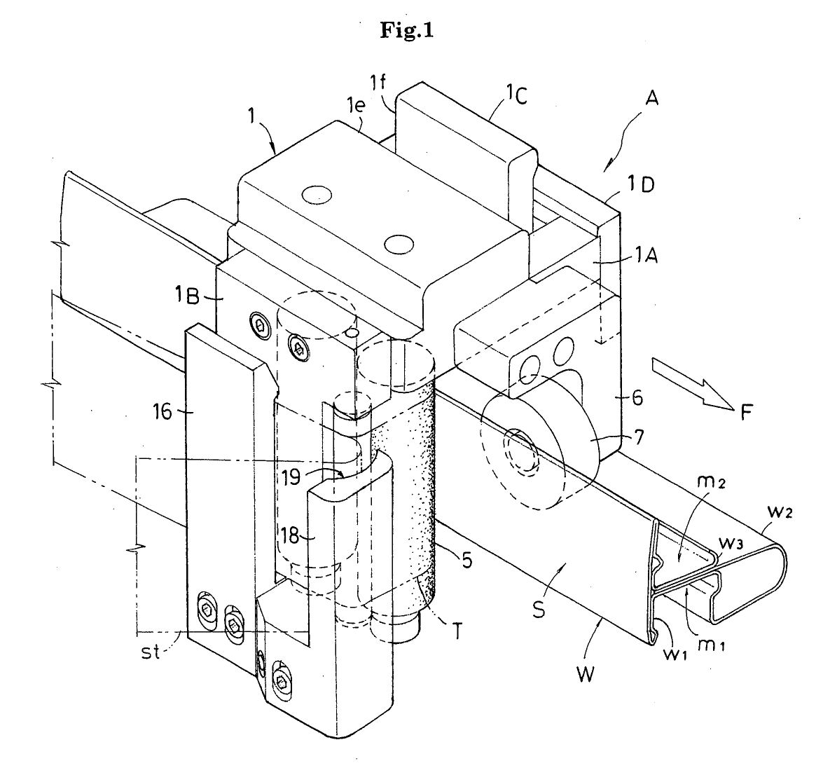

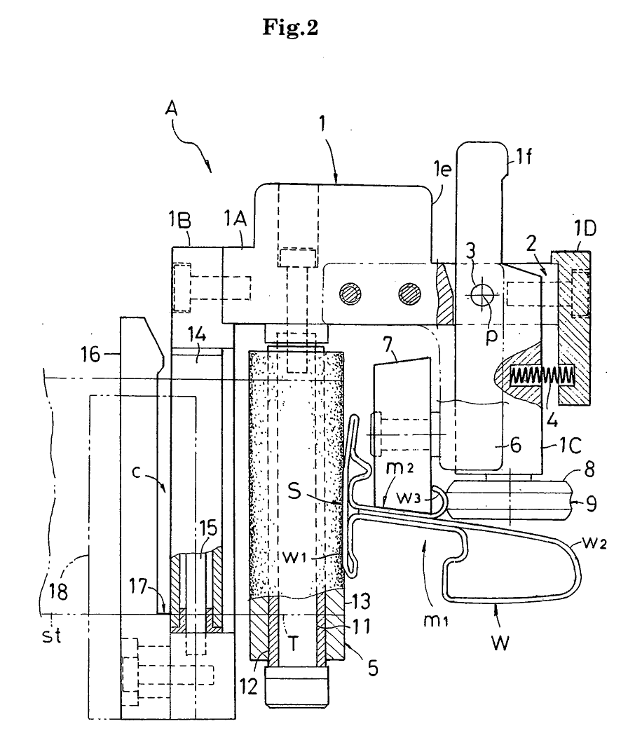

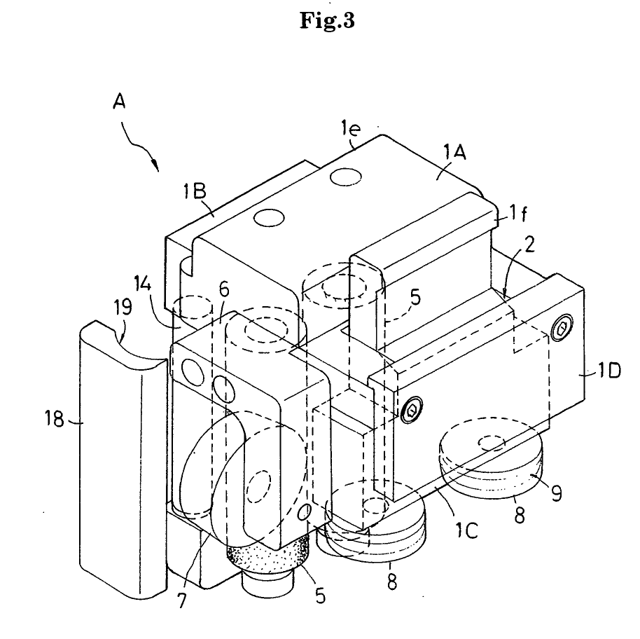

FIG. 1 is a perspective view of an adhesive tape joining apparatus A which is mounted on a workpiece, FIG. 2 is a front view of the adhesive tape joining apparatus A which is mounted on the workpiece, and FIG. 3 is a perspective view of the adhesive tape joining apparatus A seen from the opposite side.

Further, a workpiece W according to the present example is a door sash of an automobile, and an apparatus for joining a black adhesive tape to the outer side face of the workpiece W in place of black coating will be described below.

The workpiece W is configured by welding through presswork of a single steel plate. This workpiece W has an outer frame w1 shaped in a longitudinal wall at the lateral outside that is the outer face of the door of the work W. and the workpiece W is formed with a cross section that a hollow lateral frame w2 thrusting from this outer frame w1 toward the inside of the door (the right side in FIG. 2) is connected. Then, between a hollow region of the lateral frame w2 and the outer frame w1, a window glass mounting groove m1 is formed being directed downward. In addition, at right and left middle region of the upper face of the lateral frame w2, a rib w3 is protruded along the longitudinal direction of the workpiece. Between this rib w3 and the outer frame w1, a weather strip mounting groove m2 is formed. Then, the outer face at the follow region at the outer frame w1 (the left outer lateral side in FIG. 2) becomes a tape joining face S. On this tape joining face S, an adhesive tape T is joined by a manual fashion by using an adhesive tape joining apparatus A according to the present invention. As the adhesive tape T, an adhesive tape with a separator that is wider than the tape joining face S is used.

The adhesive tape joining apparatus A may join the adhesive tape T being guided and engaged to the workpiece W while moving forward along the workpiece longitudinal direction by the manual labor. In the following description, as a matter of convenience, a direction F of joining and moving the adhesive tape joining apparatus A is called as a front direction, and a door inside and outside directions that are perpendicular to the tape joining direction are called as right and left directions.

The main body 1 of the adhesive tape joining apparatus A is formed by a hard resin material. As shown in FIG. 1 and FIG. 2, the main body 1 is configured by a first bracket 1A shaped in an angular block, a second bracket 1B that is coupled by a bolt to be perpendicular downward to the lower end of this first bracket 1A, a movable bracket 1C that is supported to the first bracket 1A capable of swinging around a support point p directed in back and front directions so as to be opposed to the second bracket 1B, and a third bracket 1D that is connected to other end of the first bracket 1A through a bolt being downward perpendicular thereto.

The movable bracket 1C is pivotally connected to the first bracket 1A capable of swinging in a lateral direction around the support point p via a support shaft 3 being inserted in an opening 2 formed penetrating the first bracket 1A upward and downward. In addition, the movable bracket 1C is biased swinging in a direction separated from the third bracket 1B by a compression coil spring 4 intervened between the movable bracket 1 C and the third bracket 1B.

On the lower face at one end of the first bracket 1A, a pair of back and forth rollers 5 that can freely idle around a longitudinal axial core is mounted downward like a cantilever being supported by a shaft. In addition, on a fixed bracket 6 that is connected to the front end face of the first bracket 1A through a bolt, as the first guide member, a first guide roller 7 capable of idling around is mounted being supported by a shaft around the lateral axial core.

Further, on the lower end face of the movable bracket 1C, as shown in FIG. 2, as a second guide member, a pair of back and front second guide rollers 8 is mounted being supported by a shaft around a longitudinal axial core.

The first guide roller 7 is formed by a hard resin material excellent in smoothness in a slightly taper shape. Then, this first guide roller 7 is inserted and engaged in a weather strip mounting groove m2 at the workpiece W to be guided along its groove bottom face. In addition, the second guide roller 8 is also formed by a hard resin material excellent in smoothness. The outer circumferential face of this second guide roller 8 contacts the convex curved side face of the rib w3 with pressure, which is curved and protruded on the upper face of the lateral frame w2. In addition, on the outer circumferential face of the second guide roller 8, a guide groove 9, which is shallowly concave curved in accordance with the convex curved side face of the rib w3, is firmed circularly. By engaging this guide groove 9 to the rib w3, the second guide roller can roll and move stably along the rib w3.

In this way, when the fixed first guide roller 7 and the movable second guide roller 8 are engaged to the workpiece W from different directions, the adhesive tape joining apparatus A is positioned and its posture is kept with respect to the workpiece W. In this case, when the workpiece W is sandwiched from right and left directions by a pair of back and front joining rollers 5 and a pair of back and front second guide rollers 8 elastically contacting four points, the posture in the workpiece longitudinal direction of the adhesive tape joining apparatus A is stably kept.

The joining roller 5 externally fits a tubular axis 12 to a fixed core axis 11 coupled to the first bracket 1A so as to freely idle and is configured to cover sponge-like elastic layer 13 with this tubular axis 12. In other words, in the case that the adhesive tape joining apparatus A is engaged at a predetermined position and a predetermined posture with respect to the workpiece W, the joining roller 4 is pressed on the tape joining face S of the workpiece W while being elastically transformed in moderation.

At the front end of the second bracket 1B, a tape supply roller 14 is supported by a shaft around a longitudinal axial core freely idling so as to be opposed to the joining roller 5 at the front side in parallel. This tape supply roller 14 is formed by a hard resin material excellent in smoothness and is supported by a fixed support shaft 15 to freely idle.

In addition, a platy tape guide 16 formed by a hard resin material is attached and fixed on the lower part of the outer face of the second bracket 1B, and between this tape guide 16 and the outer side face of the second bracket 1B, a tape insertion gap c released back and force and upward is formed. A bottom end of the tape insertion gap c becomes a tape positioning part 17. When the lower side edge of the adhesive tape T inserted in this tape insertion gap c is accepted and supported by the tape positioning part 17, positioning of the adhesive tape T is carried out in a width direction. Further, the tape guide 16 is attached in an upper and lower direction, namely, in a tape width direction so that its position can be adjusted.

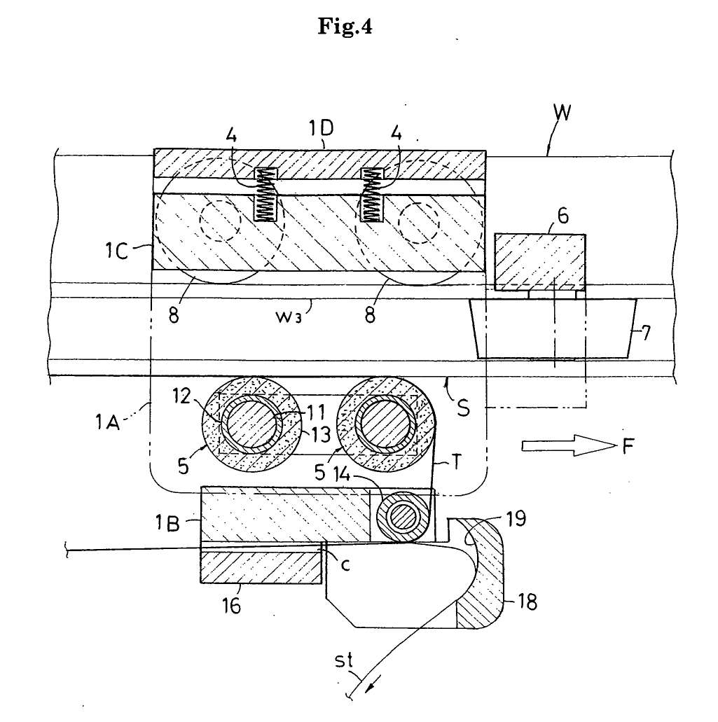

In addition, at the front end side of the lower part of the outer side face in the second bracket 1B, a separator guide 18 made of a hard resin material is attached and fixed. This separator guide 18 is arranged at the front position of the tape supply roller 14 to be opposed to the tape supply roller 14 with an appropriate interval, and further, is arranged slightly lower than the tape supply roller 14. As shown in FIG. 1, FIG. 3, and FIG. 4, a separator guide face 19 that is concave-curved opposed to the tape supply roller 14 is formed at a backward face of this separator guide 18. This separator guide 18 is also attached in an upper and lower direction, namely, in a tape width direction so that its position can be adjusted.

The adhesive tape joining apparatus A according to the present invention is configured as described above. Next, a step to apply the adhesive tape T on the workpiece W by using the apparatus A of the above-described example will be described below.

At first, an operator covers the workpiece W while enlarging a gap between the joining roller 5 and the second guide roller 8 by swinging the movable bracket 1C against the compression coil spring 4, and the first guide roller 7 is engaged in the weather strip mounting groove m2 on the upper face of the workpiece. After that, by freely biasing and swinging the movable bracket 1C, the workpiece W is elastically sandwiched from right and left by the second guide roller 8 and the joining roller 5. Further, using a boss portion 1e formed on the upper face of the second bracket 1B shown from FIG. 1 to FIG. 3 as a support of fingers, drawing a finger hanging part 1f elongated upward from the movable bracket 1C to the side of the boss portion 1e, it is possible to swing the movable bracket 1C by one hand.

Next, after inserting the adhesive tape T with a separator through the tape insertion gap c so that its separator st is located at the lateral outer side, peeling off the separator st from the front end of the adhesive tape T, the adhesive face is exposed. Winding and guiding the adhesive tape T of which adhesive face is exposed by means of the tape supply roller 14, the adhesive tape T is pasted on a predetermined position of the tape joining face S of the workpiece W to be temporarily jointed. In this case, at a tape winding region of the tape supply roller 14, the separator st peeled off from the adhesive tape T is guided by the separator guide face 19 of the separator guide 18 to be guided to the rear outside.

After that, winding the adhesive tape T of which adhesive face is exposed by the joining roller 5, the adhesive tape T is elastically pressed on the joining face S. In this state, by manually moving the adhesive tape joining apparatus A along the workpiece W, it is possible to continuously paste the adhesive tape T on the tape joining face S while positioning the adhesive tape T in a width direction.

In this case, moving the adhesive tape joining apparatus A to the front side F, when the adhesive tape T is moved relatively to the front side F, the separator st is guided being reversed on the separator guide face 19 of the separator guide 18 to be fed in a direction separated from the joining roller 5. Accordingly, even in the case of joining the adhesive tape T while moving the adhesive tape joining apparatus A upward or downward at the longitudinal portion of the workpiece W, it is possible to prevent the separated separator st from being involved in the adhesive tape T to come close to the tape joining face S or from interrupting the forward movement of the adhesive tape joining apparatus A in advance.

Further, upper and lower protruding portions of the adhesive tape T that is pasted on the tape adhesive face S are pasted being folded and involved at the opposite ends of the longitudinal outer frame W1 in a later step.

The present invention is not limited to the above-described embodiment and it can be practiced being modified as described below.

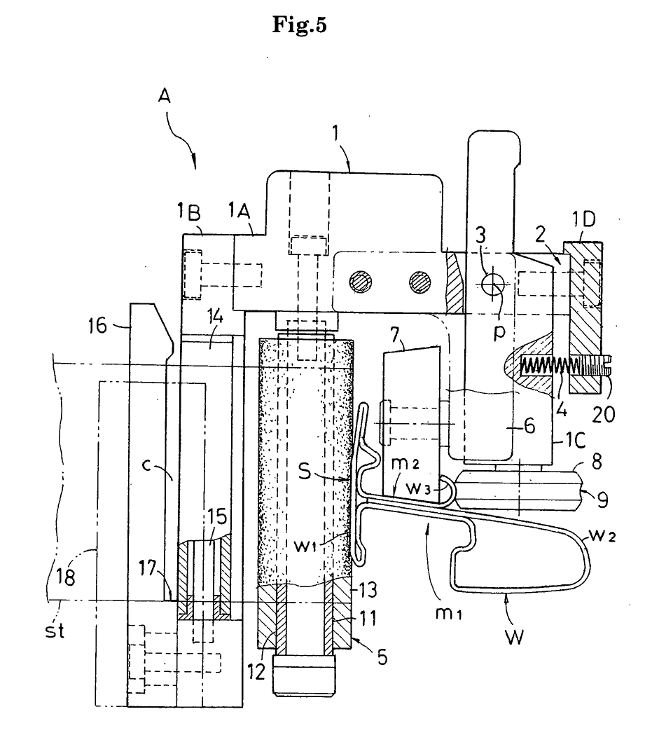

(1) As shown in FIG. 5, the present invention is configured so that the end portion at the fixed side of the compression coil spring 4 to swing and bias the movable block 1C is accepted by a screw 20 that is mounted on the third block 1D. In this configuration, a spring load is adjusted by adjusting forward and backward movement of the screw 20. In other words, swinging bias force to be given to the movable block 1C, namely, the elastic pressing force to the workpiece W of the second guide roller 8 can be varied and adjusted. Further, the movable block 1C is equivalent to the movable bracket according to the present invention.

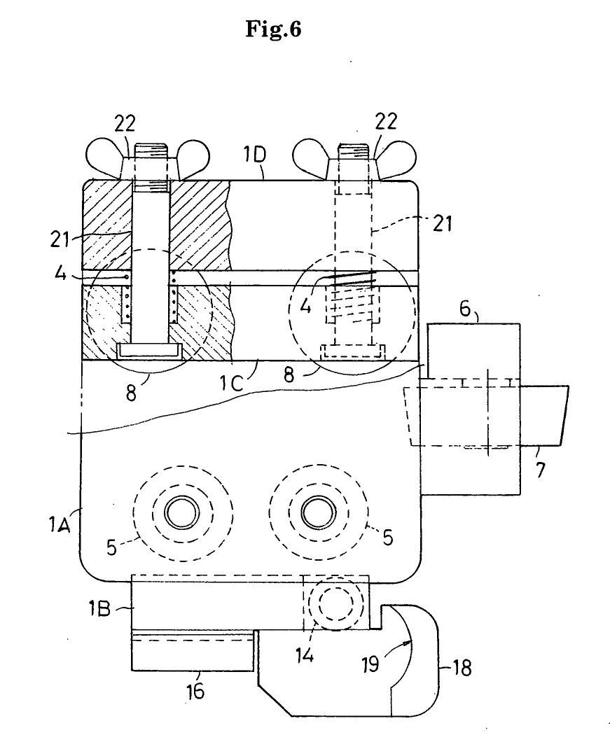

(2) As shown in FIG. 6, the movable block 1C is slidably supported by a pair of back and forth rods with a head 21 mounted on the movable block 1C in a lateral direction. Due to this configuration, the present invention can be also practiced in such a manner that the movable block 1C is slidably biased so as to be in parallel with the side of the roller joining roller 5 by the compression coil spring 4 externally fitted to the rod with a head 21. In this case, by adjusting and operating a nut 22 which is fitted at the external end portion of the rod with a head 21 to adjust the head position of the rod with a head 21 right and left, the initial position of the movable block 1C, namely, the initial position of the second guide roller (the second guide member) 8 can be adjusted.

(3) Other than the case of using the compression coil spring 4 as an elastic body to bias and bring the movable block 1C close to the side of the joining roller 5, a rubber material can be also used. In addition, in the configuration to freely and swingably support the movable block 1C, a twisting spring externally fitted to the support shaft 3 also can be used as an elastic body to bias and bring the movable block 1C close to the side of the joining roller 5.

(4) According to the above-described example, the first guide member to be engaged to the workpiece W is defined as the single first guide roller 7 of the front part in a forward moving direction, and the second guide member is defined as a pair of back and forward second guide rollers 8, however, the following configuration may be also available. In other words, engaging at least any one of the first guide member 7 or the second guide member 8 to the workpiece W, the present embodiment can be configured by a guide block made of a hard resin material excellent in smoothness.

The present invention may be embodied in other specific forms without departing from the spirit or essential attributes thereof and, accordingly, reference should be made to the appended claims, rather than to the foregoing specification, as indicating the scope of the invention.

What is claimed is:

1. An adhesive tape joining apparatus which supplies an adhesive tape to a joining roller winding the adhesive tape around the joining roller while moving forward along a workpiece and joins this adhesive tape on a tape joining face of the workpiece by pressing the adhesive tape against the tape joining face, the apparatus comprising:
a joining roller which joins the supplied adhesive tape to a main body that is moved and operated along the tape joining face of the workpiece by pressing the adhesive tape against the tape joining face of the workpiece and can be elastically transformed;
a first guide member which determines the position of the main body with respect to the workpiece being engaged with the outer face of the workpiece which is different from the tape joining face at a front position of the joining roller; and
a second guide member which is engaged with the workpiece at the portion of the opposite side of the tape joining face;
wherein
the first guide member is mounted being fixed at a predetermined position of the main body and the second guide member is mounted on a movable bracket which is attached to the main body; and
the movable bracket having the second guide member mounted thereto is biased to the side of the joining roller by an elastic body.

2. The adhesive tape joining apparatus according to claim 1,
wherein
the movable bracket is supported to the main body swinging freely around a support point which is directed forward.

3. The adhesive tape joining apparatus according to claim 2,
wherein
the movable bracket is supported so as to be capable of swinging by a third bracket which is fixed to the main body so as to be located at the opposite side of a bias direction of the movable bracket, and
a support shaft which is inserted from back and forth of the main body inserting the movable bracket in an opening formed by the main body and the movable bracket when the movable bracket is fixed to a concave side formed on the main body; and
providing an elastic body between the third bracket and the movable bracket, the movable bracket is biased to the side of the joining roller.

4. The adhesive tape joining apparatus according to claim 3,
wherein
the elastic body is a compression coil spring; and
the adhesive tape joining apparatus is configured so that an end portion at a fixed side directed to the side of the third bracket of the compression coil spring is accepted by a screw which is attached to the third bracket.

5. The adhesive tape joining apparatus according to claim 4,
wherein
the screw can move back and forward toward a movable bracket.

6. The adhesive tape joining apparatus according to claim 2, comprising:
the third bracket which is arranged at the opposite side of a bias direction of the movable bracket; and
a rod which is mounted penetrating through the third bracket and the movable bracket so that its front end arrives at the main body;
wherein
the adhesive tape joining apparatus is configured so as to move the movable bracket slidably toward the side of the joining roller.

7. The adhesive tape joining apparatus according to claim 6,
wherein
a compressing coil spring is externally mounted to the rod between a movable bracket and a third bracket.

8. The adhesive tape joining apparatus according to claim 1,
wherein
the movable bracket comprises a finger hanging part in order to move the movable bracket backward against the elastic body.

9. The adhesive tape joining apparatus according to claim 1,
wherein
the movable bracket is configured so that a movement limitation position at a bias direction can be varied and adjusted.

10. The adhesive tape joining apparatus according to claim 1,
wherein
the movable bracket is configured so as to able to vary and adjust a bias force by the elastic body.

11. The adhesive tape joining apparatus according to claim 1,
wherein
the second guide member is configured by a second guide roller which is idled around a rotational axial core approximately in parallel with the rotational axial core of the joining roller.

12. The adhesive tape joining apparatus according to claim 11,
wherein
the second guide roller is pressed and contacted to the outer convex curved face of a rib with pressure which is protruded along the longitudinal direction of the workpiece, and a guide groove concave curved in the outer circumferential face of this second guide roller is formed circularly.
